(19) United States
(12) Patent Application Publication
(10) Pub. No.: US 2026/0189149 A1
(43) Pub. Date: Jul. 2, 2026

(54) HALF-BRIDGE FLYBACK CONVERTER, CONTROL METHOD AND CONTROL CIRCUIT

(71) Applicant: Zhuhai Nanxin Semiconductor Technology Co., Ltd., Zhuhai City (CN)

(72) Inventors: Changle Xu, Zhuhai City (CN); Yang Lu, Zhuhai City (CN); Lin Feng, Zhuhai City (CN); Jianlong Gao, Zhuhai City (CN); Nan Wang, Zhuhai City (CN)

(21) Appl. No.: 19/434,014

(22) Filed: Dec. 29, 2025

(30) Foreign Application Priority Data
Dec. 28, 2024 (CN) 202411960949.6

(51) Int. Cl. H02M 3/335; H02M 1/00; H02M 3/00

(52) U.S. Cl. CPC H02M 3/33571; H02M 1/0058; H02M 3/01; H02M 3/33592

(57) ABSTRACT

Embodiments of the present disclosure provide a half-bridge flyback converter, a control method, and a control circuit. The control method includes: controlling a second primary switching transistor to be ON for a first duration in a first switching period in a case where the half-bridge flyback converter operates in a free resonant state, and in response to detecting, based on sampled voltage information of a secondary power circuit, that the second primary switching transistor is turned on, controlling a secondary switching transistor to be ON for a second duration, such that the half-bridge flyback converter is reverse-magnetized to generate a negative magnetizing current, and thus a voltage across the first primary switching transistor is reduced to zero. By controlling the first primary switching transistor to turn on, zero-voltage switching of the first primary switching transistor is achieved. With the method, noise of the half-bridge flyback converter is reduced.

### CROSS REFERENCE TO THE RELATED APPLICATIONS

This application is based upon and claims priority to Chinese Patent Application No. 202411960949.6, filed on Dec. 28, 2024, the entire contents of which are incorporated herein by reference.

### TECHNICAL FIELD

Embodiments of the present disclosure relate to the technical field of integrated circuits, and in particular, relate to a half-bridge flyback converter, a control method thereof, a control circuit, and a chip.

### BACKGROUND

In a control scheme of a half-bridge flyback converter, a protocol controller transmits a feedback signal, i.e., output power information, to a primary controller via an isolation optocoupler. The primary controller controls turn-on or turn-off of a first primary switching transistor and a second primary switching transistor in the half-bridge flyback converter based on the feedback signal from the optocoupler. The first primary switching transistor is connected in series to a primary winding, and the second primary switching transistor is connected in parallel to the primary winding. Under a light load condition, the half-bridge flyback converter enters a discontinuous conduction mode (DCM) to reduce a switching loss of the half-bridge flyback converter. However, a current stored in a magnetizing inductor is insufficient, which prevents the first primary switching transistor from achieving zero-voltage switching.

In the related art, the second primary switching transistor may be turned on before the first primary switching transistor is turned on, such that a magnetizing current crosses zero and becomes negative, thereby achieving the zero voltage switching of the first primary switch. However, a resonant capacitor in the half-bridge flyback converter is generally a multi-layer ceramic capacitor (MLCC). Due to a limited capacitance of the MLCC and an effect of a direct current bias (DC-bias), a capacitance of the resonant capacitor drops significantly. In a case where the second primary switching transistor is turned on, an excessive voltage fluctuation is caused across the resonant capacitor, which results in a failure to achieve zero-voltage switching of the first primary switching transistor at a low output voltage.

### SUMMARY

Embodiments of the present disclosure provide a half-bridge flyback converter, and a control method, a control circuit, and a chip thereof, which are capable of achieving zero-voltage switching of a first primary switching transistor in a discontinuous conduction mode over a wide range of output voltages of the half-bridge flyback converter, thereby improving an efficiency of the half-bridge flyback converter in the discontinuous conduction mode, and reducing an audible noise of the half-bridge flyback converter.

In a first aspect, the embodiments of the present disclosure provide a control method for a half-bridge flyback converter. The half-bridge flyback converter includes a primary power circuit and a secondary power circuit coupled to the primary power circuit, wherein the primary power circuit includes a primary winding and a first primary switching transistor and a second primary switching transistor connected in series between a voltage input terminal and ground, and the secondary power circuit includes a secondary winding and a secondary switching transistor and an output capacitor electrically connected to two terminals of the secondary winding respectively.

The control method includes: in a case where the half-bridge flyback converter operates in a free resonant state, controlling, in a first switching period, the second primary switching transistor to be ON for a first duration; in response to detecting, based on sampled voltage information of the secondary power circuit, that the second primary switching transistor is turned on, controlling the secondary switching transistor to be ON for a second duration to cause a magnetizing current to become a negative current; and in response to the secondary switching transistor being turned off, at a moment having a dead time away from a turn-off moment of the secondary switching transistor, controlling the first primary switching transistor to turn on.

In some embodiments, before controlling, in the first switching period, the second primary switching transistor to be ON for the first duration, the method further includes: controlling, in the first switching period, the second primary switching transistor to be ON for a third duration to cause the magnetizing current to be zero.

In some embodiments, prior to the first switching period, the half-bridge flyback converter continuously operates for N second switching periods, wherein N is an integer greater than or equal to 1.

In the first switching period, before controlling, in the first switching period, the secondary switching transistor to be ON for the third duration, the method further includes: in a case where the half-bridge flyback converter continuously operates in a critical conduction mode for the N second switching periods, controlling, in the second switching period, the second primary switching transistor to be ON for a fourth duration to cause the magnetizing current to be a negative current, wherein the fourth duration is greater than the third duration; or in a case where the half-bridge flyback converter continuously operates in a discontinuous conduction mode for the N second switching periods, controlling, in the second switching period, the second primary switching transistor to be ON for the third duration.

In some embodiments, prior to the first switching period, the half-bridge flyback converter continuously operates in the critical conduction mode for N second switching periods, wherein N is an integer greater than or equal to 1.

Prior to controlling, in the first switching period, the second primary switching transistor to be ON for the first duration, the method further includes: controlling, in the first switching period, the second primary switching transistor to turn off.

In some embodiments, before controlling, in the first switching period, the second primary switching transistor to turn off, the method further includes: controlling, in the second switching period, the first primary switching transistor to be ON for a fifth duration; and controlling, in the first switching period, the first primary switching transistor to be ON for a sixth duration, wherein the sixth duration is less than the fifth duration.

In some embodiments, the controlling the secondary switching transistor to be ON for the second duration in response to detecting, based on the sampled voltage information of the secondary power circuit, that the second primary switching transistor is turned on includes: determining a turn-on moment of the secondary switching transistor based on a valley value of a drain voltage of the secondary switching transistor in the free resonant state; and controlling, at the turn-on moment, the secondary switching transistor to be ON for the second duration.

In a second aspect, the embodiments of the present disclosure provide a control circuit for a half-bridge flyback converter. The half-bridge flyback converter includes a primary power circuit and a secondary power circuit coupled to the primary power circuit, wherein the primary power circuit includes a primary winding and a first primary switching transistor and a second primary switching transistor connected in series between a voltage input terminal and ground, and the secondary power circuit includes a secondary winding and a secondary switching transistor and an output capacitor electrically connected to two terminals of the secondary winding respectively.

The control circuit includes a primary control module and a secondary control module. The primary control module is configured to, in a case where the half-bridge flyback converter operates in a free resonant state, control, in a first switching period, the second primary switching transistor to be ON for a first duration.

The secondary control module is configured to, in response to detecting, based on sampled voltage information of the secondary power circuit, that the second primary switching transistor is turned on, control the secondary switching transistor to be ON for a second duration to cause a magnetizing current to become a negative current. The primary control module is further configured to, in response to the secondary switching transistor being turned off, at a moment having a dead time away from a turn-off moment of the secondary switching transistor, control the first primary switching transistor to turn on.

In some embodiments of the present disclosure, the primary control module is further configured to control, in the first switching period, the second primary switching transistor to be ON for a third duration to cause the magnetizing current to be zero.

In some embodiments, prior to the first switching period, the half-bridge flyback converter continuously operates for N second switching periods, wherein N is an integer greater than or equal to 1.

The primary control module is further configured to: in a case where the half-bridge flyback converter continuously operates in a critical conduction mode for the N second switching periods, control, in the second switching period, the second primary switching transistor to be ON for a fourth duration to cause the magnetizing current to be a negative current, wherein the fourth duration is greater than the third duration; or in a case where the half-bridge flyback converter continuously operates in a discontinuous conduction mode for the N second switching periods, control, in the second switching period, the second primary switching transistor to be ON for the third duration.

In some embodiments, prior to the first switching period, the half-bridge flyback converter continuously operates in the critical conduction mode for N second switching periods, wherein N is an integer greater than or equal to 1.

The primary control module is further configured to control, in the first switching period, the second primary switching transistor to turn off.

In some embodiments, the primary control module is further configured to: control, in the second switching period, the first primary switching transistor to be ON for a fifth duration, and control, in the first switching period, the first primary switching transistor to be ON for a sixth duration, wherein the sixth duration is less than the fifth duration.

In some embodiments, the secondary control module is further configured to: determine a turn-on moment of the secondary switching transistor based on a valley value of a drain voltage of the secondary switching transistor in the free resonant state; and at the turn-on moment, control the secondary switching transistor to be ON for the second duration.

In a third aspect, the embodiments of the present disclosure provide a half-bridge flyback converter. The half-bridge flyback converter includes a primary power circuit and a secondary power circuit coupled to the primary power circuit, and any control circuit according to the second aspect. The primary power circuit includes a primary winding and a first primary switching transistor and a second primary switching transistor connected in series between a voltage input terminal and ground, and the secondary power circuit includes a secondary winding and a secondary switching transistor and an output capacitor electrically connected to two terminals of the secondary winding respectively;

In a fourth aspect, the embodiments of the present disclosure further provide a chip. The chip includes a processor and a storage medium. The processor, when running a computer program stored in the storage medium, is caused to perform the steps in any method according to the first aspect.

The technical solutions according to the present disclosure provide a control method for a half-bridge flyback converter. By controlling a second primary switching transistor to be ON for a first duration in a first switching period in a case where the half-bridge flyback converter operates in a free resonant state, and in response to detecting, based on sampled voltage information of a secondary power circuit, that the second primary switching transistor is turned on, controlling a secondary switching transistor to be ON for a second duration, the half-bridge flyback converter may be reverse-magnetized to generate a negative magnetizing current, and thus a voltage across the first primary switching transistor is reduced to zero. By controlling the first primary switching transistor to turn on in response to the secondary switching transistor being turned off and at a moment having a dead time away from a turn-off moment of the secondary switching transistor, zero-voltage switching of the first primary switching transistor is achieved.

In addition, because energy for zero-voltage switching of the first primary switching transistor comes from the output capacitor, and the output capacitor has a large capacitance and is generally a solid-state capacitor, a voltage fluctuation of the output capacitor is relatively small in a case where the secondary switching transistor is turned on. Therefore, an audible noise of the half-bridge flyback converter is reduced. Furthermore, zero-voltage switching of the first primary switching transistor is achieved in the discontinuous conduction mode over a wide range of output voltages of the half-bridge flyback converter, so as to improve the efficiency of the half-bridge flyback converter in the discontinuous conduction mode.

### BRIEF DESCRIPTION OF THE DRAWINGS

For clearer descriptions of the technical solutions according to the embodiments of the present disclosure, accompanying drawings used for describing the embodiments are hereinafter briefly introduced. Apparently, the accompanying drawings hereinafter are only intended to illustrate some embodiments of the present disclosure instead of limiting the present disclosure.

FIG. 1 is a schematic structural diagram of a half-bridge flyback converter in the prior art

FIG. 2 is a schematic diagram of operating waveforms of a half-bridge flyback converter in the prior art.

FIG. 3 is a schematic structural diagram of a half-bridge flyback converter according to some embodiments of the present disclosure.

FIG. 4 is a schematic structural diagram of another half-bridge flyback converter according to some embodiments of the present disclosure.

FIG. 5 is a schematic flowchart of a control method according to some embodiments of the present disclosure.

FIG. 6 is a schematic diagram of operating waveforms of a half-bridge flyback converter according to some embodiments of the present disclosure.

FIG. 7 is a schematic diagram of operating waveforms of another half-bridge flyback converter according to some embodiments of the present disclosure.

FIG. 8 is a schematic diagram of operating waveforms of another half-bridge flyback converter according to some embodiments of the present disclosure.

FIG. 9 is a schematic diagram of operating waveforms of another half-bridge flyback converter according to some embodiments of the present disclosure.

### DETAILED DESCRIPTION OF THE EMBODIMENTS

For clearer descriptions of the objectives, technical solutions, and advantages of embodiments of the present disclosure clearer, the embodiments of the present disclosure are described in detail with reference to accompanying drawings. Obviously, the embodiments described herein are merely exemplary ones, but are not all the embodiments of the present disclosure. Based on the described embodiments of the present disclosure, all other embodiments derived by persons of skilled in the art without any creative efforts shall fall within the protection scope of the present disclosure.

Unless otherwise defined, all terms (including technical and scientific terms) used herein have the same meaning as commonly understood by persons skilled in the art to which the subject matter of the present disclosure belongs. It may be further understood that terms, such as those defined in commonly used dictionaries, should be interpreted as having meanings that is consistent with their meanings in the context of the specification and the relevant art and may not be interpreted in an idealized or overly formal sense unless expressly defined herein. As used herein, a statement that two or more parts are “connected” to each other shall mean that the parts are joined together either directly or through one or more intermediate parts.

The terms “example” and “embodiment” in the present disclosure signify that the specific characteristic, structures or features described with reference to the embodiments may be covered in at least one embodiment of the present disclosure. The term “embodiment,” when used in various positions of the description, neither indicates the same embodiment, nor indicates an independent or optional embodiment that is exclusive of the other embodiments. A person skilled in the art would implicitly or explicitly understand that the embodiments described in the present disclosure may be incorporated with other embodiments.

Terms such as “first,” “second,” and the like in the specifications, claims and the accompanying drawings of the present disclosure are intended to distinguish different objects but are not intended to define a specific sequence. Such terms may explicitly or implicitly indicate one or more such features.

The term “and/or” in the present disclosure is merely an association relationship for describing associated objects, which represents that there may exist three types of relationships. For example, the phrase “A and/or B” may indicate (A), (B), or (A and B). In addition, the forward-slash symbol “/” generally represents an “or” relationship between associated objects before and after the symbol.

In the description of the present disclosure, the terms “a plurality of” and “at least two” signify two or more, unless otherwise specified. Likewise, the terms “a plurality of groups” and “at least two groups” signify two or more groups (including two groups).

For better understanding of the technical solutions according to the embodiments of the present disclosure, the technical solutions of the present disclosure are clearly and completely described with reference to the accompanying drawings of the embodiments of the present disclosure.

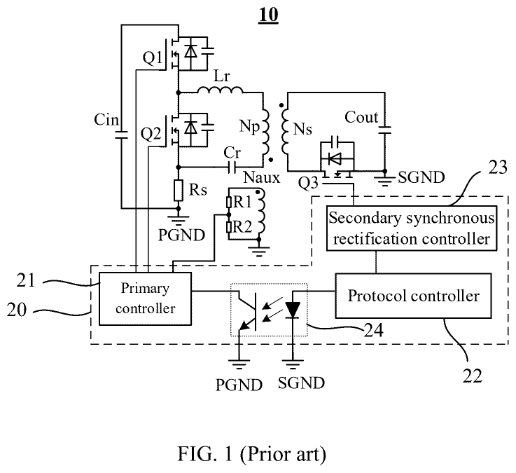

FIG. 1 is a schematic structural diagram of a half-bridge flyback converter in the prior art. As illustrated in FIG. 1, the half-bridge flyback converter 10 includes an input capacitor Cin, a first primary switching transistor Q1, a second primary switching transistor Q2, a resonant inductor Lr, a primary winding Np, a resonant capacitor Cr, and a sampling resistor Rs.

A first plate of the input capacitor Cin is electrically connected to a voltage input terminal and a first terminal of the first primary switching transistor Q1, a second terminal of the first primary switching transistor Q1 is electrically connected to a first terminal of the resonant inductor Lr and a first terminal of the second primary switching transistor Q2, a second terminal of the resonant inductor Lr is electrically connected through the primary winding Np and the resonant capacitor Cr to a first terminal of the sampling resistor Rs and a second terminal of the second primary switching transistor Q2, and a second terminal of the sampling resistor Rs and a second plate of the input capacitor Cin are connected to a power ground PGND.

The half-bridge flyback converter 10 further includes an auxiliary winding Naux, a first auxiliary sampling resistor R1, and a second auxiliary sampling resistor R2. A first terminal of the auxiliary winding Naux is electrically connected to a first terminal of the first auxiliary sampling resistor R1, a second terminal of the auxiliary winding Naux is connected to the power ground PGND, and a second terminal of the first auxiliary sampling resistor R1 is connected to the power ground PGND through the second auxiliary sampling resistor R2.

The half-bridge flyback converter 10 further includes a secondary winding Ns, an output capacitor Cout, and a secondary switching transistor Q3. A first terminal of the secondary winding Ns is electrically connected to a voltage output terminal and a first plate of the output capacitor Cout, a second terminal of the secondary winding Ns is electrically connected to a first terminal of the secondary switching transistor Q3, and a second terminal of the secondary switching transistor Q3 and a second plate of the output capacitor Cout are connected to a signal ground SGND.

The half-bridge flyback converter 10 further includes a controller 20. The controller 20 includes a primary controller 21, a protocol controller 22, a secondary synchronous rectification controller 23, and an isolation optocoupler 24. A first input terminal of the primary controller 21 is electrically connected to a connection node between the second terminal of the first auxiliary sampling resistor R1 and a first terminal of the second auxiliary sampling resistor R2, a second input terminal of the primary controller 21 is electrically connected to an output terminal of the isolation optocoupler 24, and two output terminals of the primary controller 21 are electrically connected to a control terminal of the first primary switching transistor Q1 and a control terminal of the second primary switching transistor Q2, respectively.

A first output terminal of the secondary synchronous rectification controller 23 is electrically connected to a control terminal of the secondary switching transistor Q3, a second output terminal of the secondary synchronous rectification controller 23 is electrically connected to an input terminal of the protocol controller 22, and an output terminal of the protocol controller 22 is electrically connected to an input terminal of the isolation optocoupler 24. For example, the isolation optocoupler 24 includes a light-emitting diode and a phototransistor. A positive electrode of the light-emitting diode is electrically connected to the output terminal of the protocol controller 22, and a negative electrode of the light-emitting diode is connected to the signal ground SGND. A first terminal of the phototransistor is electrically connected to the second input terminal of the primary controller 21, and a second terminal of the phototransistor is connected to the power ground PGND.

The secondary synchronous rectification controller 23 may control turn-on or turn-off of the secondary switching transistor Q3 and generate a feedback signal representing the turn-on or turn-off of the secondary switching transistor Q3. The secondary synchronous rectification controller 23 may transmit the feedback signal to the protocol controller 22. The protocol controller 22 transmits the feedback signal, i.e., output power information, to the primary controller 21 via the isolation optocoupler 24. The primary controller 21 may control the turn-on or turn-off of the first primary switching transistor Q1 and the second primary switching transistor Q2 based on the feedback signal from the optocoupler.

Under a light load condition, the half-bridge flyback converter 10 enters a discontinuous conduction mode to reduce a switching loss of the half-bridge flyback converter 10. However, in a case where the half-bridge flyback converter 10 is in the discontinuous conduction mode, a current stored by the primary winding Np is insufficient at a moment when the first primary switching transistor Q1 is turned on, and thus zero-voltage switching of the first primary switching transistor Q1 fails to be achieved.

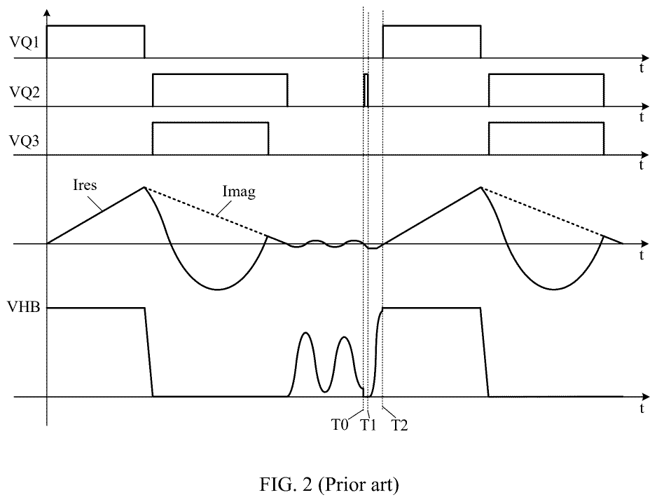

To solve the above technical problem, the second primary switching transistor Q2 may be turned on prior to turn-on of the first primary switching transistor Q1, such that a magnetizing current crosses zero and becomes negative, thereby achieving zero-voltage switching of the first primary switching transistor Q1, as illustrated in FIG. 2. FIG. 2 is a schematic diagram of operating waveforms of a half-bridge flyback converter in the related art.

At a moment T0, a voltage VQ1 of a first primary control signal and a voltage VQ3 of a secondary control signal are both at a low level, such that the first primary switching transistor Q1 and the secondary switching transistor Q3 are both turned off. The primary controller 21 pulls up (i.e., raises or increases) a voltage VQ2 of a second primary control signal to turn on the second primary switching transistor Q2. A half-bridge midpoint voltage VHB is pulled down (i.e., lowered or decreased) to zero, and a magnetizing current Imag and a resonant current Ires are zero.

At a moment T1, the primary controller 21 pulls down (i.e., lowers or decreases) the voltage VQ2 of the second primary control signal to turn off the second primary switching transistor Q2. In this case, the half-bridge midpoint voltage VHB is maintained at zero, and the magnetizing current Imag and the resonant current Ires are negative currents, wherein the negative current refers to a current flowing from the primary winding Np to the first primary switching transistor Q1.

At a moment T2, the primary controller 21 pulls up (i.e., raises or increases) the voltage VQ1 of the first primary control signal to turn on the first primary switching transistor Q1. The half-bridge midpoint voltage VHB is pulled up (i.e., raised or increased) to an input voltage, and the magnetizing current Imag and the resonant current Ires become zero, such that zero-voltage switching of the first primary switching transistor Q1 is achieved.

However, the resonant capacitor Cr generally uses an MLCC, and a capacitance of the MLCC is typically several hundreds of nF. Moreover, the higher a voltage across the MLCC is, the more pronounced a DC-bias phenomenon becomes, causing the capacitance of the resonant capacitor Cr to drop significantly. In a case where the second primary switching transistor Q2 is turned on, an excessive voltage drop occurs across the resonant capacitor Cr, which introduces certain noise and, at a low output voltage, for example, an output voltage of 3.3V, and thus zero-voltage switching of the first primary switching transistor Q1 fails to be achieved.

In view of this, some embodiments of the present disclosure provide a control method for a half-bridge flyback converter. By controlling the second primary switching transistor to be ON for a first duration in a case where the half-bridge flyback converter operates in a free resonant state, and in response to detecting, based on sampled voltage information of a secondary power circuit, that the second primary switching transistor is turned on, controlling a secondary switching transistor to be ON for a second duration, the half-bridge flyback converter may be reverse-magnetized to generate a negative magnetizing current, and thus a voltage across the first primary switching transistor is reduced to zero. By controlling the first primary switching transistor to turn on in response to the secondary switching transistor being turned off and at a moment having a dead time away from a turn-off moment of the secondary switching transistor, zero-voltage switching of the first primary switching transistor is achieved.

In addition, because energy for zero-voltage switching of the first primary switching transistor comes from the output capacitor, and the output capacitor has a large capacitance and is generally a solid-state capacitor, a voltage fluctuation of the output capacitor is relatively small in a case where the secondary switching transistor is turned on. Therefore, an audible noise of the half-bridge flyback converter is reduced. Furthermore, zero-voltage switching of the first primary switching transistor is achieved in the discontinuous conduction mode over a wide range of output voltages of the half-bridge flyback converter, so as to improve the efficiency of the half-bridge flyback converter in the discontinuous conduction mode.

The technical solutions according to the present disclosure are described in great detail hereinafter with reference to some specific embodiments.

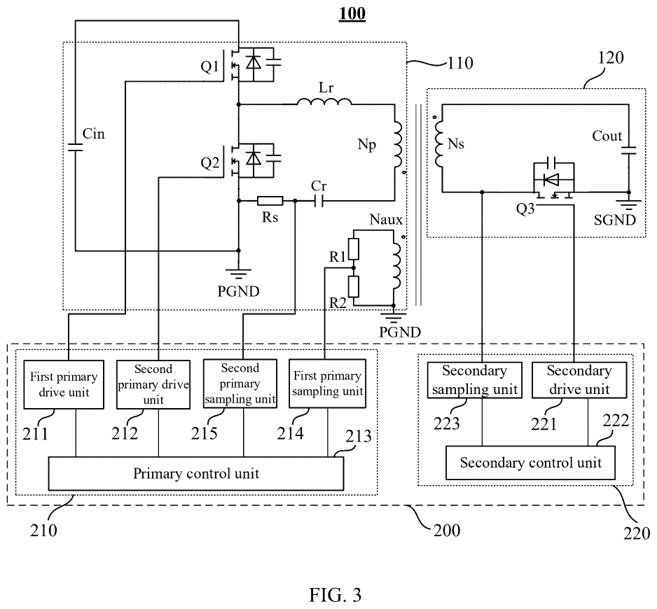

FIG. 3 is a schematic structural diagram of a half-bridge flyback converter 100 according to some embodiments of the present disclosure. As illustrated in FIG. 3, the half-bridge flyback converter 100 includes a primary power circuit 110 and a secondary power circuit 120, wherein the primary power circuit 110 and the secondary power circuit 120 are coupled. The primary power circuit 110 includes a first primary switching transistor Q1, a second primary switching transistor Q2, and a primary winding Np.

A drain of the first primary switching transistor Q1 is electrically connected to a voltage input terminal, a source of the first primary switching transistor Q1 is electrically connected to a drain of the second primary switching transistor Q2, and a source of the second primary switching transistor Q2 is electrically connected to a power ground PGND.

Exemplarily, as illustrated in FIG. 3, the primary power circuit 110 further includes a resonant inductor Lr, a resonant capacitor Cr, an input capacitor Cin, and a sampling resistor Rs. A first plate of the input capacitor Cin is the voltage input terminal, and a second plate of the input capacitor Cin is electrically connected to the power ground PGND. The voltage input terminal is connected to the power ground PGND sequentially via the first primary switching transistor Q1 and the second primary switching transistor Q2. A connection node between the source of the first primary switching transistor Q1 and the drain of the second primary switching transistor Q2 is connected to the power ground PGND sequentially via the resonant inductor Lr, the primary winding Np, the resonant capacitor Cr, and the sampling resistor Rs.

For example, as illustrated in FIG. 3, a first terminal of the resonant inductor Lr is electrically connected to the connection node between the source of the first primary switching transistor Q1 and the drain of the second primary switching transistor Q2, a second terminal of the resonant inductor Lr is electrically connected to a first terminal of the primary winding Np, a second terminal of the primary winding Np is electrically connected to a second terminal of the resonant capacitor Cr, a first terminal of the resonant capacitor Cr is electrically connected to a second terminal of the sampling resistor Rs, and a first terminal of the sampling resistor Rs is connected to the power ground PGND.

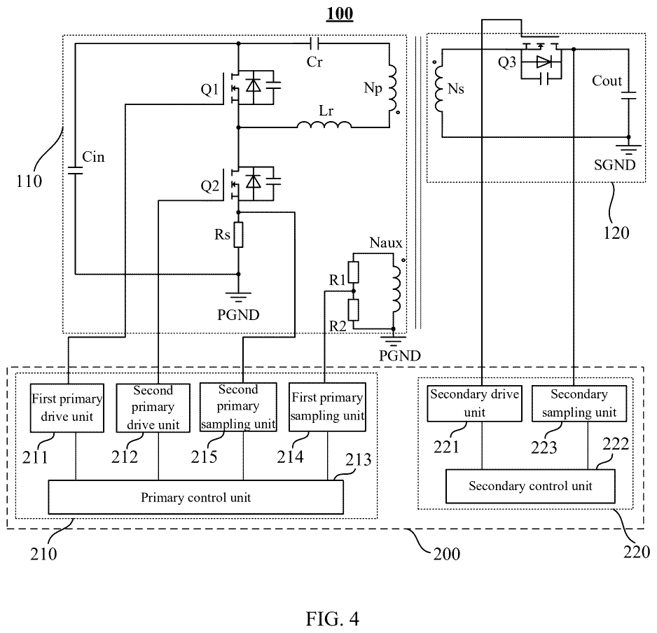

In some other embodiments, as illustrated in FIG. 4, which is a schematic structural diagram of another half-bridge flyback converter according to some embodiments of the present disclosure, a first plate of the input capacitor Cin is the voltage input terminal, and a second plate of the input capacitor Cin is electrically connected to the power ground PGND. The voltage input terminal is connected to the power ground PGND sequentially through the first primary switching transistor Q1, the second primary switching transistor Q2, and the sampling resistor Rs, that is, a source of the second primary switching transistor Q2 is connected to the power ground PGND via the sampling resistor Rs. The connection node between the source of the first primary switching transistor Q1 and the drain of the second primary switching transistor Q2 is electrically connected to the voltage input terminal sequentially via the resonant inductor Lr, the primary winding Np, and the resonant capacitor Cr.

As illustrated in FIG. 4, the voltage input terminal is electrically connected to a first terminal of the resonant capacitor Cr, a second terminal of the resonant capacitor Cr is electrically connected to a first terminal of the primary winding Np, a second terminal of the primary winding Np is electrically connected to a second terminal of the resonant inductor Lr, and a first terminal of the resonant inductor Lr is electrically connected to the connection node between the source of the first primary switching transistor Q1 and the drain of the second primary switching transistor Q2. The source of the second primary switching transistor Q2 is electrically connected to a first terminal of the sampling resistor Rs, and a second terminal of the sampling resistor Rs is connected to the power ground PGND.

Referring again to FIG. 3 and FIG. 4, the secondary power circuit 120 includes a secondary winding Ns, an output capacitor Cout, and a secondary switching transistor Q3. A first plate of the output capacitor Cout is a voltage output terminal, and a second plate of the output capacitor Cout is connected to a signal ground SGND. Two terminals of the secondary winding Ns are electrically connected to the secondary switching transistor Q3 and the output capacitor Cout, respectively, wherein the secondary switching transistor Q3 and the output capacitor Cout are connected in series with each other.

Exemplarily, as illustrated in FIG. 3, a first terminal of the secondary winding Ns is electrically connected to the first plate of the output capacitor Cout, a second terminal of the secondary winding Ns is electrically connected to a drain of the secondary switching transistor Q3, and a source of the secondary switching transistor Q3 and the second plate of the output capacitor Cout are both connected to the signal ground SGND. In some other embodiments, as illustrated in FIG. 4, a first terminal of the secondary winding Ns is electrically connected to a source of the secondary switching transistor Q3, a drain of the secondary switching transistor Q3 is electrically connected to the voltage output terminal (i.e., the first plate of the output capacitor), and a second terminal of the secondary winding Ns is electrically connected to the second plate of the output capacitor Cout. Both the second terminal of the secondary winding Ns and the second plate of the output capacitor Cout are connected to the signal ground SGND.

The secondary winding Ns is coupled to the primary winding Np, and the first terminal of the secondary winding Ns and the second terminal of the primary winding Np are corresponding polarity terminals.

Referring again to FIG. 3 and FIG. 4, the primary power circuit 110 further includes an auxiliary winding Naux, a first auxiliary sampling resistor R1, and a second auxiliary sampling resistor R2. A first terminal of the auxiliary winding Naux is electrically connected to the power ground PGND sequentially via the first auxiliary sampling resistor R1 and the second auxiliary sampling resistor R2, and a second terminal of the auxiliary winding Naux is connected to the power ground PGND.

For example, as illustrated in FIG. 3 and FIG. 4, the first terminal of the auxiliary winding Naux is electrically connected to a first terminal of the first auxiliary sampling resistor R1, a second terminal of the first auxiliary sampling resistor R1 is electrically connected to a first terminal of the second auxiliary sampling resistor R2, and a second terminal of the second auxiliary sampling resistor R2 and the second terminal of the auxiliary winding Naux are both connected to the power ground PGND.

The auxiliary winding Naux is coupled to the secondary winding Ns, and a first terminal of the auxiliary winding Naux and the first terminal of the secondary winding Ns are corresponding polarity terminals.

The half-bridge flyback converter 100 further includes a control circuit 200. Three output terminals of the control circuit 200 are electrically connected to a control terminal of the first primary switching transistor Q1, a control terminal of the second primary switching transistor Q2, and a control terminal of the secondary switching transistor Q3, respectively, to control the turning off of the first primary switching transistor Q1, the second primary switching transistor Q2, and the secondary switching transistor Q3. The control terminal of the first primary switching transistor Q1, the control terminal of the second primary switching transistor Q2, and the control terminal of the secondary switching transistor Q3 are gate.

The control circuit 200 is configured to perform steps of a control method according to the present disclosure. The specific control method is described in detail hereinafter.

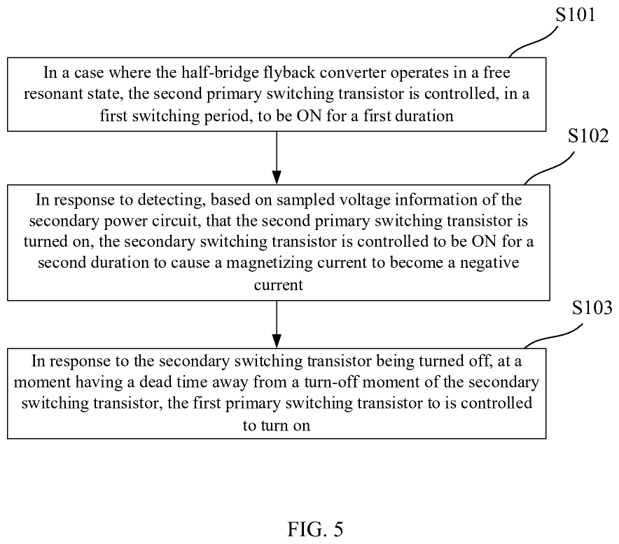

FIG. 5 is a schematic flowchart of a control method according to an embodiment of the present disclosure. As illustrated in FIG. 5, the control method specifically includes the following steps.

In S101, in a case where the half-bridge flyback converter operates in a free resonant state, the second primary switching transistor is controlled, in a first switching period, to be ON for a first duration.

Exemplarily, as illustrated in FIG. 3 and FIG. 4, the control circuit 200 includes a primary control module 210 and a secondary control module 220. The primary control module 210 includes a first primary drive unit 211, a second primary drive unit 212, and a primary control unit 213. For example, the primary control unit 213 is an asymmetrical half-bridge (AHB) controller. A first output terminal of the primary control unit 213 is electrically connected to a control terminal of the first primary switching transistor Q1 via the first primary drive unit 211, and a second output terminal of the primary control unit 213 is electrically connected to a control terminal of the second primary switching transistor Q2 via the second primary drive unit 212.

The secondary control module 220 includes a secondary drive unit 221 and a secondary control unit 222. For example, the secondary control unit 222 is a synchronous rectification (SR) controller. An output terminal of the secondary control unit 222 is electrically connected to a control terminal of the secondary switching transistor Q3 via the secondary drive unit 221.

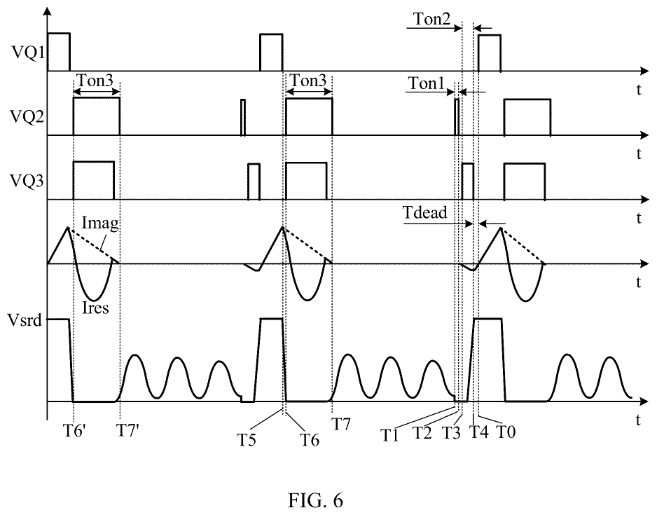

FIG. 6 is a schematic diagram of operating waveforms of a half-bridge flyback converter according to some embodiments of the present disclosure. As illustrated in FIG. 6, the half-bridge flyback converter 100 continuously operates for multiple switching periods in a discontinuous conduction mode. At a moment T1 in the first switching period, a voltage VQ1 of a first primary control signal, a voltage VQ2 of a second primary control signal, and a voltage VQ3 of a secondary control signal are maintained at a low level; the primary control unit 213 controls, based on the voltage VQ1 of the first primary control signal, the first primary drive unit 211 to maintain the first primary switching transistor Q1 turned off; the primary control unit 213 controls, based on the voltage VQ2 of the second primary control signal, the primary control unit 213 controls the second primary drive unit 212 to maintain the second primary switching transistor Q2 turned off; and the secondary control unit 222 controls, based on the voltage VQ3 of the secondary control signal, the secondary drive unit 221 to maintain the secondary switching transistor Q3 turned off.

Apparently, the first primary switching transistor Q1 is not turned on, and the half-bridge flyback converter 100 is in the free resonant state. In this case, the primary control unit 213 pulls up (i.e., raises or increases) the voltage VQ2 of the second primary control signal, and controls, based on the voltage VQ2 of the second primary control signal, the second primary drive unit 212 to turn on the second primary switching transistor Q2. A drain voltage Vsrd of the secondary switching transistor Q3 is pulled down to zero.

For example, the moment T1 may be a moment corresponding to a valley voltage of a half-bridge midpoint in the free resonant state during the first switching period, or may be another moment in the free resonant state during the first switching period.

Following the moment T1 in the first switching period, and at a moment T2 having a first duration Ton1 away from the moment T1, the voltage VQ1 of the first primary control signal and the voltage VQ3 of the secondary control signal are maintained at a low level; the primary control unit 213 controls, based on the voltage VQ1 of the first primary control signal, the first primary drive unit 211 to maintain the first primary switching transistor Q1 turned off; and the secondary control unit 222 controls, based on the voltage VQ3 of the secondary control signal, the secondary drive unit 221 to turn off the secondary switching transistor Q3.

In this case, the primary control unit 213 pulls down (i.e., lowers or decreases) the voltage VQ2 of the second primary control signal, and controls, based on the voltage VQ2 of the second primary control signal, the second primary drive unit 212 to turn off the second primary switching transistor Q2. Thus, a communication pulse signal for instructing the secondary switching transistor Q3 to turn on is generated, that is, the voltage VQ2 of the second primary control signal between the moment T1 and the moment T2.

In S102, in response to detecting, based on sampled voltage information of the secondary power circuit, that the second primary switching transistor is turned on, the secondary switching transistor is controlled to be ON for a second duration to cause a magnetizing current to become a negative current.

Exemplarily, still referring to FIG. 3 and FIG. 4, the secondary control module 220 further includes a secondary sampling unit 223. An input terminal of the secondary sampling unit 223 is electrically connected to the drain of the secondary switching transistor Q3, and an output terminal of the secondary sampling unit 223 is electrically connected to an input terminal of the secondary control unit 222. The secondary sampling unit 223 may sample the drain voltage Vsrd of the secondary switching transistor Q3, and transmit the drain voltage Vsrd of the secondary switching transistor Q3 to the secondary control unit 222.

The secondary control unit 222 may determine the sampled voltage information of the secondary power circuit 120 based on the drain voltage Vsrd of the secondary switching transistor Q3. For example, the sampled voltage information may be a secondary synchronous rectification detection signal indicating whether the secondary power circuit 120 is conductive, a change in a slope of a falling edge of the drain voltage Vsrd, a voltage valley value of the drain voltage Vsrd, a drop of the drain voltage Vsrd, or the like.

In a case where the sampled voltage information satisfies a predetermined condition, the secondary switching transistor Q3 is controlled to turn on. For example, in a case where the sampled voltage information is the secondary synchronous rectification detection signal, the predetermined condition is a secondary synchronous rectification turn-on signal indicating that the secondary power circuit 120 is to be turned on, and the sampled voltage information satisfying the predetermined condition means that the secondary synchronous rectification detection signal is the secondary synchronous rectification turn-on signal indicating that the secondary power circuit 120 is to be turned on. In a case where the sampled voltage information is the change in the slope of the falling edge of the drain voltage Vsrd, the predetermined condition is a slope change threshold, and the sampled voltage information satisfying the predetermined condition means that the slope of the falling edge of the drain voltage Vsrd is greater than or equal to the predetermined slope change threshold.

As illustrated in FIG. 6, in the first switching period, in a case where it is determined that the sampled voltage information satisfies the predetermined condition, at a moment T3 later than the moment T1, the voltage VQ1 of the first primary control signal and the voltage VQ2 of the second primary control signal are maintained at a low level. The primary control unit 213 controls, based on the voltage VQ1 of the first primary control signal, the first primary drive unit 211 to maintain the first primary switching transistor Q1 turned off, and controls, based on the voltage VQ2 of the second primary control signal, the second primary drive unit 212 to maintain the second primary switching transistor Q2 turned off.

In this case, the secondary control unit 222 pulls up (i.e., raises or increases) the voltage VQ3 of the secondary control signal, and controls, based on the voltage VQ3 of the secondary control signal, the secondary drive unit 221 to turn on the secondary switching transistor Q3. The output capacitor Cout supplies energy to magnetize the secondary winding Ns, that is, the half-bridge flyback converter 100 is reverse-magnetized.

Following the moment T3 in the first switching period, and at a moment T4 having a second duration Ton2 away from the moment T3, the voltage VQ1 of the first primary control signal and the voltage VQ2 of the second primary control signal are maintained at a low level. The primary control unit 213 controls, based on the voltage VQ1 of the first primary control signal, the first primary drive unit 211 to maintain the first primary switching transistor Q1 turned off, and controls, based on the voltage VQ2 of the second primary control signal, the second primary drive unit 212 to maintain the second primary switching transistor Q2 turned off.

In this case, the secondary control unit 222 pulls down (lowers or decreases) the voltage VQ3 of the secondary control signal and controls, based on the voltage VQ3 of the secondary control signal, the secondary drive unit 221 to turn off the secondary switching transistor Q3. The primary winding Np and a parasitic capacitance of the first primary switching transistor Q1 begin to resonate. Energy stored in the secondary winding Ns is transferred to the primary winding Np, such that the magnetizing current Imag becomes a negative current, and a voltage across a drain and a source of the first primary switching transistor Q1 is reduced to zero.

It should be noted that FIG. 6 only exemplarily illustrates that a turn-on moment T3 of the secondary switching transistor Q3 is later than a turn-off moment T2 of the second primary switching transistor Q2. In practical applications, it is also possible that the turn-on moment T3 of the secondary switching transistor Q3 is earlier than the turn-off moment T2 of the second primary switching transistor Q2.

In S103, in response to the secondary switching transistor being turned off, at a moment having a dead time away from a turn-off moment of the secondary switching transistor, the first primary switching transistor to is controlled to turn on.

Exemplarily, as illustrated in FIG. 6, following the moment T4 in the first switching period, and at a moment T0 having a dead time Tdead away from the moment T4, the voltage VQ2 of the second primary control signal and the voltage VQ3 of the secondary control signal are maintained at a low level. The primary control unit 213 controls, based on the voltage VQ2 of the second primary control signal, the second primary drive unit 212 to maintain the second primary switching transistor Q2 turned off. The secondary control unit 222 controls, based on the voltage VQ3 of the secondary control signal, the secondary drive unit 221 to maintain the secondary switching transistor Q3 turned off.

In this case, the voltage across the drain and the source of the first primary switching transistor Q1 is zero. The primary control unit 213 pulls up (i.e., raises or increases) the voltage VQ1 of the first primary control signal, and controls, based on the voltage VQ1 of the first primary control signal, controls the first primary drive unit 211 to turn on the first primary switching transistor Q1, such that zero-voltage switching of the first primary switching transistor Q1 is achieved.

Still referring to FIG. 6, at a moment T5 in the first switching period, the voltage VQ2 of the second primary control signal and the voltage VQ3 of the secondary control signal are maintained at a low level. The primary control unit 213 controls, based on the voltage VQ2 of the second primary control signal, the second primary drive unit 212 to maintain the second primary switching transistor Q2 turned off. The secondary control unit 222 controls, based on the voltage VQ3 of the secondary control signal, the secondary drive unit 221 to maintain the secondary switching transistor Q3 turned off.

In this case, the magnetizing current Imag increases from zero to a predetermined value. Then, the primary control unit 213 pulls down (i.e., lowers or decreases) the voltage VQ1 of the first primary control signal, and controls, based on the voltage VQ1 of the first primary control signal, the first primary drive unit 211 to turn off the first primary switching transistor Q1.

In summary, in a case where the half-bridge flyback converter 100 operates in the first switching period of the discontinuous conduction mode before the first primary switching transistor Q1 is turned on, the half-bridge flyback converter 100 operates in the free resonant state. Then, in the first switching period, by controlling the secondary switching transistor Q3 to be ON for a period of time, the half-bridge flyback converter 100 may be reverse-magnetized to generate a negative magnetizing current Imag. The voltage across the first primary switching transistor Q1 is reduced to zero, thereby achieving zero-voltage switching of the first primary switching transistor Q1.

In addition, because energy for zero-voltage switching of the first primary switching transistor Q1 comes from the output capacitor Cout, and the output capacitor Cout has a large capacitance and is generally a solid-state capacitor, a voltage fluctuation of the output capacitor Cout is relatively small in a case where the secondary switching transistor Q3 is turned on. Therefore, an audible noise of the half-bridge flyback converter is reduced. Furthermore, zero-voltage switching of the first primary switching transistor Q1 is achieved in the discontinuous conduction mode over a wide range of output voltages of the half-bridge flyback converter 100, so as to improve the efficiency of the half-bridge flyback converter 100 in the discontinuous conduction mode.

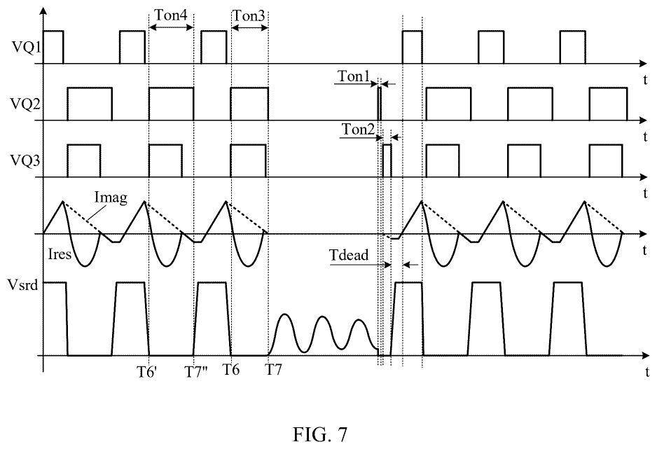

On the basis of the above embodiments, prior to the first switching period, the half-bridge flyback converter 100 continuously operates for N second switching periods, wherein N is an integer greater than or equal to 1. The half-bridge flyback converter 100 may continuously operate for N second switching periods in the discontinuous conduction mode, as illustrated in FIG. 6. The half-bridge flyback converter 100 may also continuously operate for N second switching periods in a critical conduction mode, as illustrated in FIG. 7. FIG. 7 is a schematic diagram of operating waveforms of another half-bridge flyback converter according to some embodiments of the present disclosure.

In some embodiments, prior to S101, the control method further includes:
S201, in the first switching period, controlling the second primary switching transistor to be ON for a third duration to cause the magnetizing current to be zero.

Exemplarily, as illustrated in FIG. 6 and FIG. 7, at a moment T6 in the first switching period, the voltage VQ1 of the first primary control signal is maintained at a low level. The primary control unit 213 controls, based on the voltage VQ1 of the first primary control signal, the first primary drive unit 211 to maintain the first primary switching transistor Q1 turned off.

In this case, the primary control unit 213 pulls up (i.e., raises or increases) the voltage VQ2 of the second primary control signal, and controls, based on the voltage VQ2 of the second primary control signal, the second primary drive unit 212 to turn on the second primary switching transistor Q2. The secondary control unit 222 pulls up (i.e., raises or increases) the voltage VQ3 of the secondary control signal, and controls, based on the voltage VQ3 of the secondary control signal, the secondary drive unit 221 to turn on the secondary switching transistor Q3. The resonant capacitor Cr and the resonant inductor Lr begin to resonate. The primary power circuit 110 transfers energy to the secondary power circuit 120, and the magnetizing current Imag decreases linearly.

Following the moment T6 in the first switching period, and at a moment T7 having a third duration Ton3 away from the moment T6, the magnetizing current Imag is zero. The primary control unit 213 pulls down (lowers or decreases) the voltage VQ2 of the second primary control signal, and controls, based on the voltage VQ2 of the second primary control signal, the second primary drive unit 212 to turn off the second primary switching transistor Q2.

In this case, the voltage VQ1 of the first primary control signal and the voltage VQ3 of the secondary control signal are maintained at a low level. The primary control unit 213 controls, based on the voltage VQ1 of the first primary control signal, the first primary drive unit 211 to maintain the first primary switching transistor Q1 turned off. The secondary control unit 222 controls, based on the voltage VQ3 of the secondary control signal, the secondary drive unit 221 to maintain the secondary switching transistor Q3 turned off. Thus, the half-bridge flyback converter 100 enters the free resonant state.

In some embodiments, prior to the first switching period, the half-bridge flyback converter 100 continuously operates for N second switching periods in the discontinuous conduction mode. The control method prior to S201 further includes:
S301, in the second switching period, controlling the second primary switching transistor to be ON for the third duration.

Exemplarily, as illustrated in FIG. 6, at a moment T6′ in a second switching period, the voltage VQ1 of the first primary control signal is maintained at a low level. The primary control unit 213 controls, based on the voltage VQ1 of the first primary control signal, the first primary drive unit 211 to maintain the first primary switching transistor Q1 turned off.

In this case, the primary control unit 213 pulls up (i.e., raises or increases) the voltage VQ2 of the second primary control signal, and controls, based on the voltage VQ2 of the second primary control signal, the second primary drive unit 212 to turn on the second primary switching transistor Q2. The secondary control unit 222 pulls up (i.e., raises or increases) the voltage VQ3 of the secondary control signal, and controls, based on the voltage VQ3 of the secondary control signal, the secondary drive unit 221 to turn on the secondary switching transistor Q3. The resonant capacitor Cr and the resonant inductor Lr begin to resonate. The primary power circuit 110 transfers energy to the secondary power circuit 120, and the magnetizing current Imag decreases linearly.

Following the moment T6′ in the second switching period, and at a moment T7′ having a third duration Ton3 away from the moment T6′, the magnetizing current Imag is zero. The primary control unit 213 pulls low the voltage VQ2 of the second primary control signal, and controls, based on the voltage VQ2 of the second primary control signal, the second primary drive unit 212 to turn off the second primary switching transistor Q2.

In this case, the voltage VQ1 of the first primary control signal and the voltage VQ3 of the secondary control signal are maintained at a low level. The primary control unit 213 controls, based on the voltage VQ1 of the first primary control signal, the first primary drive unit 211 to maintain the first primary switching transistor Q1 turned off. The secondary control unit 222 controls, based on the voltage VQ3 of the secondary control signal, the secondary drive unit 221 to maintain the secondary switching transistor Q3 turned off. Thus, the half-bridge flyback converter 100 enters the free resonant state.

In some embodiments, prior to the first switching period, the half-bridge flyback converter 100 continuously operates for N second switching periods in the critical conduction mode. Prior to S201, the control method further includes:
S301′, in the second switching period, controlling the second primary switching transistor to be ON for a fourth duration to cause the magnetizing current to be a negative current.

Exemplarily, as illustrated in FIG. 7, at a moment T6′ in a second switching period, the voltage VQ1 of the first primary control signal is maintained at a low level. The primary control unit 213 controls, based on the voltage VQ1 of the first primary control signal, the first primary drive unit 211 to maintain the first primary switching transistor Q1 turned off.

In this case, the primary control unit 213 pulls up (i.e., raises or increases) the voltage VQ2 of the second primary control signal, and controls, based on the voltage VQ2 of the second primary control signal, the second primary drive unit 212 to turn on the second primary switching transistor Q2. The secondary control unit 222 pulls up (i.e., raises or increases) the voltage VQ3 of the secondary control signal, and controls, based on the voltage VQ3 of the secondary control signal, the secondary drive unit 221 to turn on the secondary switching transistor Q3. The resonant capacitor Cr and the resonant inductor Lr begin to resonate. The primary power circuit 110 transfers energy to the secondary power circuit 120, and the magnetizing current Imag decreases linearly.

Following the moment T6′ in the second switching period, and at a moment having a third duration Ton3 away from the moment T6′, the magnetizing current Imag is zero. Then, following the moment T6′ in the second switching period, and at a moment T7′ having a fourth duration Ton4 away from the moment T6′, since Ton4>Ton3, the magnetizing current Imag is a negative current.

In this case, the primary control unit 213 pulls down (lowers or decreases) the voltage VQ2 of the second primary control signal, and controls, based on the voltage VQ2 of the second primary control signal, the second primary drive unit 212 to turn off the second primary switching transistor Q2. The voltage VQ1 of the first primary control signal and the voltage VQ3 of the secondary control signal are maintained at a low level. The primary control unit 213 controls, based on the first primary control signal VQ1, the first primary drive unit 211 to maintain the first primary switching transistor Q1 turned off. The secondary control unit 222 controls, based on the voltage VQ3 of the secondary control signal, the secondary drive unit 221 to maintain the secondary switching transistor Q3 turned off.

Following the moment T7, in the second switching period, and at a moment having a predetermined dead time away from the moment T7′, the primary control unit 213 pulls up (i.e., raises or increases) the voltage VQ1 of the first primary control signal to enter the first switching period, and controls, based on the voltage VQ1 of the first primary control signal, the first primary drive unit 211 to turn on the first primary switching transistor Q1, such that zero-voltage switching of the first primary switching transistor Q1 is achieved.

In some embodiments, prior to the first switching period, the half-bridge flyback converter 100 continuously operates for N switching periods in the critical conduction mode. Prior to S101, the control method further includes:
S201′, in the first switching period, controlling the second primary switching transistor to turn off.

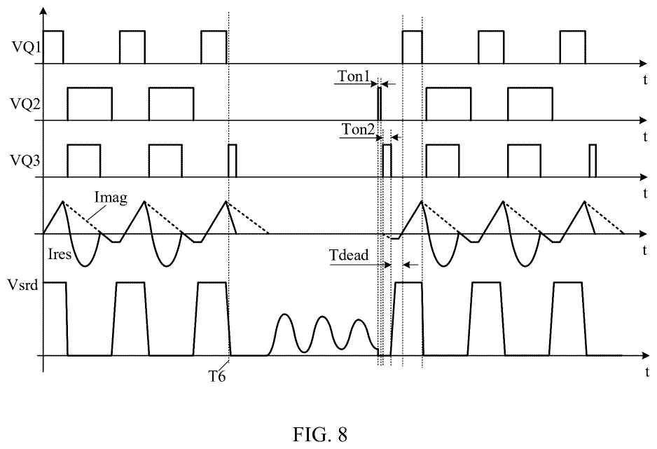

Exemplarily, FIG. 8 is a schematic diagram of operating waveforms of another half-bridge flyback converter according to some embodiments of the present disclosure. As illustrated in FIG. 8, at a moment T6 in the first switching period, the secondary control unit 222 pulls up (i.e., raises or increases) the voltage VQ3 of the secondary control signal, and pulls down (i.e., lowers or decreases) the voltage VQ3 of the secondary control signal in response to a resonant current Ires becoming zero. The secondary control unit 222 may control, based on the voltage VQ3 of the secondary control signal, the secondary drive unit 221 to turn on the secondary switching transistor Q3 at the moment T6, and to turn off the secondary switching transistor Q3 in response to the resonant current Ires becoming zero.

In the first switching period, from the moment T6 to an end of the first switching period, the voltage VQ1 of the first primary control signal and the voltage VQ2 of the second primary control signal are maintained at a low level. The primary control unit 213 controls, based on the voltage VQ1 of the first primary control signal, the first primary drive unit 211 to maintain the first primary switching transistor Q1 turned off, and controls, based on the voltage VQ2 of the second primary control signal, the second primary drive unit 212 to maintain the second primary switching transistor Q2 turned off.

In this way, in a case where the resonant current Ires crosses zero, the resonant inductor Lr and the resonant capacitor Cr no longer resonate. A voltage Vcr of the resonant capacitor Cr is greater than Np/Ns*Vout, wherein Np is a number of turns of the primary winding Np, Ns is a number of turns of the secondary winding Ns, and Vout is an output voltage of the half-bridge flyback converter 100. The magnetizing current Imag decreases linearly via the secondary switching transistor Q3 until the magnetizing current Imag is zero, and the half-bridge flyback converter 100 enters the free resonant state. Furthermore, Vcr being greater than Np/Ns*Vout ensures that the communication pulse signal for instructing the secondary switching transistor Q3 to turn on is reliably identified.

On the basis of the above embodiments, prior to S201′, the control method further includes the following steps.

In S401, in a second switching period, the first primary switching transistor is controlled to be ON for a fifth duration.

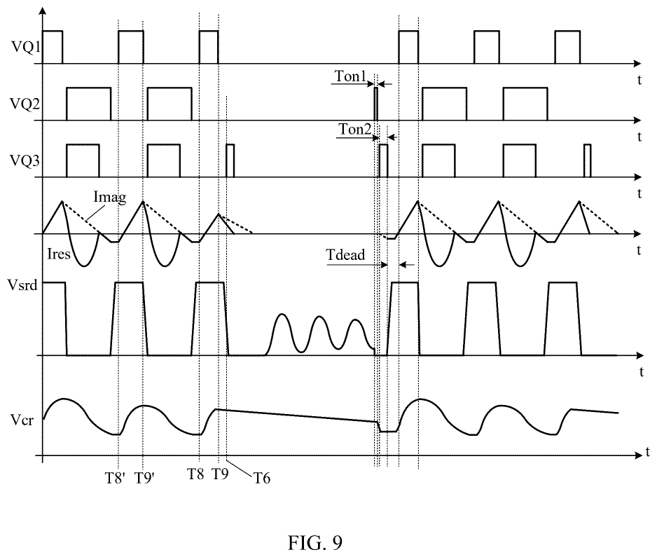

Exemplarily, FIG. 9 is a schematic diagram of operating waveforms of another half-bridge flyback converter according to some embodiments of the present disclosure. As illustrated in FIG. 9, at a moment T8′ in the second switching period, the voltage VQ2 of the second primary control signal and the voltage VQ3 of the secondary control signal are maintained at a low level; the primary control unit 213 controls, based on the voltage VQ2 of the second primary control signal, the second primary drive unit 212 to maintain the second primary switching transistor Q2 turned off; and the secondary control unit 222 controls, based on the voltage VQ3 of the secondary control signal, the secondary drive unit 221 to maintain the secondary switching transistor Q3 turned off.

In this case, the primary control unit 213 pulls up (i.e., raises or increases) the voltage VQ1 of the first primary control signal, and controls, based on the voltage VQ1 of the first primary control signal, the first primary drive unit 211 to turn on the first primary switching transistor Q1, such that the magnetizing current Imag begins to rise.

Following the moment T8′ in the second switching period, and at a moment T9′ having a fifth duration Ton5 away from the moment T8′, the magnetizing current Imag rises to a predetermined value; and the primary control unit 213 pulls down (i.e., lowers or decreases) the voltage VQ1 of the first primary control signal, and controls, based on the voltage VQ1 of the first primary control signal, the first primary drive unit 211 to turn off the first primary switching transistor Q1.

In this case, the voltage VQ2 of the second primary control signal and the voltage VQ3 of the secondary control signal are maintained at a low level; the primary control unit 213 controls, based on the voltage VQ2 of the second primary control signal, the second primary drive unit 212 to maintain the second primary switching transistor Q2 turned off; and the secondary control unit 222 controls, based on the voltage VQ3 of the secondary control signal, the secondary drive unit 221 to maintain the secondary switching transistor Q3 turned off.

In S402, in the first switching period, the first primary switching transistor is controlled to be ON for a sixth duration.

Exemplarily, as illustrated in FIG. 9, at a moment T8 in the first switching period, the voltage VQ2 of the second primary control signal and the voltage VQ3 of the secondary control signal are maintained at a low level; the primary control unit 213 controls, based on the voltage VQ2 of the second primary control signal, the second primary drive unit 212 to maintain the second primary switching transistor Q2 turned off; and the secondary control unit 222 controls, based on the voltage VQ3 of the secondary control signal, the secondary drive unit 221 to maintain the secondary switching transistor Q3 turned off.

In this case, the primary control unit 213 pulls up (i.e., raises or increases) the voltage VQ1 of the first primary control signal, and controls, based on the voltage VQ1 of the first primary control signal, the first primary drive unit 211 to turn on the first primary switching transistor Q1, such that the magnetizing current Imag begins to rise.

Following the moment T8 in the first switching period, and at a moment T9 having a sixth duration Ton6 away from the moment T8, the sixth duration Ton6 is less than the fifth duration Ton5. For example, the sixth duration Ton6 is ½, ⅓, ⅔, or the like, of the fifth duration Ton5. Thus, the magnetizing current Imag is less than the predetermined value. In this case, the primary control unit 213 pulls down (i.e., lowers or decreases) the voltage VQ1 of the first primary control signal, and controls, based on the voltage VQ1 of the first primary control signal, the first primary drive unit 211 to turn off the first primary switching transistor Q1.

At the same time, the voltage VQ2 of the second primary control signal and the voltage VQ3 of the secondary control signal are maintained at a low level; the primary control unit 213 controls, based on the voltage VQ2 of the second primary control signal, the second primary drive unit 212 to maintain the second primary switching transistor Q2 turned off; and the secondary control unit 222 controls, based on the voltage VQ3 of the secondary control signal, the secondary drive unit 221 to maintain the secondary switching transistor Q3 turned off.

Since the magnetizing current Imag is less than the predetermined value, the voltage Vcr of the resonant capacitor Cr may not be much greater than Np/Ns*Vout after the resonant current Ires crosses zero, such that a risk of overcurrent when the second primary switching transistor Q2 is turned on is reduced.

In some embodiments, a possible implementation for performing S102 is described as follows.

In S1021, a turn-on moment of the secondary switching transistor is determined based on a valley value of a drain voltage of the secondary switching transistor in the free resonant state.

Exemplarily, in the free resonant state, the drain voltage Vsrd of the secondary switching transistor Q3 oscillates, and the secondary control unit 222 may determine the sampled voltage information in the free resonant state based on the oscillation of the drain voltage Vsrd.

The sampled voltage information may include a rate of change of the drain voltage of the secondary switching transistor Q3 and a trend of change of the drain voltage of the secondary switching transistor Q3. The secondary control unit 222 may determine the drain voltage valley value based on the rate of change and the trend of change of the drain voltage of the secondary switching transistor Q3 in the free resonant state. For example, in a case where the trend of change of the drain voltage of the secondary switching transistor Q3 is decreasing and the rate of change of the drain voltage is approximately zero in the free resonant state, it may be determined that the drain voltage Vsrd has reached the drain voltage valley value.

Alternatively, the sampled voltage information may include a lowest valley voltage in each oscillation period. The lowest valley voltage in a current oscillation period is compared with the lowest valley voltage in a previous oscillation period to determine whether the lowest valley voltage in the current oscillation period is the drain voltage valley value. For example, in a case where the lowest valley voltage in the current oscillation period is greater than the lowest valley voltage in the previous oscillation period, it is determined that the lowest valley voltage in the current oscillation period is the drain voltage valley value; or in a case where the lowest valley voltage in the current oscillation period is less than or equal to the lowest valley voltage in the previous oscillation period, it is determined that the lowest valley voltage in the previous oscillation period is the drain voltage valley value. In a case where it is determined that the lowest valley voltage of the current oscillation period is not the drain voltage valley value, as time goes by, the current oscillation period is updated to a next oscillation period, and the previous oscillation period is updated to the current oscillation period. The above determination step is repeated until it is determined that the lowest valley voltage of the current oscillation period is the drain voltage valley value.

The secondary control unit 222 determines a moment corresponding to the drain voltage valley value as the turn-on moment of the secondary switching transistor Q3.

In S1022, at the turn-on moment, the secondary switching transistor is controlled to be ON for a second duration.

Exemplarily, at the turn-on moment of the secondary switching transistor Q3, the secondary control unit 222 pulls up (i.e., raises or increases) the voltage VQ3 of the secondary control signal, and controls, based on the voltage VQ3 of the secondary control signal, the secondary drive unit 221 to turn on the secondary switching transistor Q3.

The control circuit 200 according to the present disclosure includes the primary control module 210 and the secondary control module 220. The first output terminal of the primary control module 210 is electrically connected to the control terminal of the first primary switching transistor Q1 via the first primary drive unit 211, the second output terminal of the primary control module 210 is electrically connected to the control terminal of the second primary switching transistor Q2 via the second primary drive unit 212, and the output terminal of the secondary control module 220 is electrically connected to the control terminal of the secondary switching transistor Q3 via the secondary drive unit 221, as illustrated in FIG. 3 and FIG. 4.

The primary control module 210 is configured to, in a case where the half-bridge flyback converter 100 operates in a free resonant state, control, in a first switching period, the second primary switching transistor Q2 to be ON for a first duration Ton1.

The secondary control module 220 is configured to, in response to detecting, based on sampled voltage information of the secondary power circuit 120, that the second primary switching transistor Q2 is turned on, control the secondary switching transistor Q3 to be ON for a second duration Ton2 to cause a magnetizing current Imag to become a negative current.

The primary control module 210 is further configured to, in response to the secondary switching transistor Q3 being turned off, at a moment having a dead time Tdead away from a turn-off moment of the secondary switching transistor Q3, control the first primary switching transistor Q1 to turn on.

In some embodiments, the primary control module 210 is further configured to control, in the first switching period, the second primary switching transistor Q2 to be ON for a third duration Ton3 to cause the magnetizing current Imag to be zero.

In some embodiments, prior to the first switching period, the half-bridge flyback converter 100 continuously operates for N second switching periods, wherein N is an integer greater than or equal to 1.

The primary control module 210 is further configured to: in a case where the half-bridge flyback converter 100 continuously operates in a critical conduction mode for the N second switching periods, control, in the second switching period, the second primary switching transistor Q2 to be ON for a fourth duration Ton4 to cause the magnetizing current Imag to be a negative current, wherein the fourth duration Ton4 is greater than the third duration Ton3; or in a case where the half-bridge flyback converter 100 continuously operates in a discontinuous conduction mode for N of the second switching periods, control, in the second switching period, the second primary switching transistor Q2 to be ON for the third duration Ton3.

In some embodiments, prior to the first switching period, the half-bridge flyback converter 100 continuously operates in the critical conduction mode for N second switching periods, wherein N is an integer greater than or equal to 1.

The primary control module 210 is further configured to control, in the first switching period, the second primary switching transistor Q2 to turn off.

In some embodiments, the primary control module 210 is further configured to: control, in the second switching period, the first primary switching transistor Q1 to be ON for a fifth duration Ton5; and control, in the first switching period, the first primary switching transistor Q1 to be ON for a sixth duration Ton6, wherein the sixth duration Ton6 is less than the fifth duration Ton5.

In some embodiments, the secondary control module 220 is further configured to: determine a turn-on moment of the secondary switching transistor Q3 based on a valley value of a drain voltage of the secondary switching transistor Q3 in the free resonant state; and at the turn-on moment of the secondary switching transistor Q3, control the secondary switching transistor Q3 to be ON for the first duration Ton1.

In some embodiments, still referring to FIG. 3 and FIG. 4, the primary control module 210 includes the first primary drive unit 211, the second primary drive unit 212, the primary control unit 213, a first primary sampling unit 214, and a second primary sampling unit 215.

An input terminal of the first primary sampling unit 214 is electrically connected to a connection node between the second terminal of the first auxiliary sampling resistor R1 and the first terminal of the second auxiliary sampling resistor R2, and an output terminal of the first primary sampling unit 214 is electrically connected to a first input terminal of the primary control unit 213. The first output terminal of the primary control unit 213 is electrically connected to the control terminal of the first primary switching transistor Q1 via the first primary drive unit 211, and the second output terminal of the primary control unit 213 is electrically connected to the control terminal of the second primary switching transistor Q2 via the second primary drive unit 212.

Exemplarily, as illustrated in FIG. 3, an output terminal of the second primary sampling unit 215 is electrically connected to a second input terminal of the primary control unit 213, and an input terminal of the second primary sampling unit 215 is electrically connected to a connection node between the second terminal of the sampling resistor Rs and the first terminal of the resonant capacitor Cr. In some other embodiments, as illustrated in FIG. 4, the output terminal of the second primary sampling unit 215 is electrically connected to the second input terminal of the primary control unit 213, and the input terminal of the second primary sampling unit 215 is electrically connected to a connection node between the first terminal of the sampling resistor Rs and the source of the second primary switching transistor Q2.

In some embodiments, still referring to FIG. 3 and FIG. 4, the secondary control module 220 includes the secondary drive unit 221, the secondary sampling unit 223, and the secondary control unit 222. The output terminal of the secondary control unit 222 is electrically connected to the control terminal of the secondary switching transistor Q3 via the secondary drive unit 221, and an input terminal of the secondary sampling unit 223 is electrically connected to the drain of the secondary switching transistor Q3. For example, as illustrated in FIG. 3, the input terminal of the secondary sampling unit 223 is electrically connected to a connection node between the second terminal of the secondary winding Ns and the drain of the secondary switching transistor Q3. As another example, as illustrated in FIG. 4, the input terminal of the secondary sampling unit 223 is electrically connected to a connection node between the drain of the secondary switching transistor Q3 and the first terminal of the output capacitor Cout, and an output terminal of the secondary sampling unit 223 is electrically connected to the input terminal of the secondary control unit 222.

The control circuit 200 according to the embodiments of the present disclosure is configured to perform the steps in any of the above method embodiments, includes functional modules corresponding to the method embodiments, and achieves the beneficial effects of the method embodiments, which are not described herein any further.

Some embodiments of the present disclosure further provide a chip, including a processor and a storage medium. The processor, when running a computer program stored in the storage medium, is caused to perform the steps in any of the above method embodiments, includes functional modules corresponding to the method embodiments, and achieves the beneficial effects of the method embodiments, which are not described herein any further.

Unless the context clearly indicates otherwise, the singular forms of words used herein and in the appended claims are intended to include the plural and vice versa. Thus, a reference to the singular typically includes the plural of the corresponding term. Similarly, the words “comprise” and “include” shall be interpreted as inclusive and not exclusive. Likewise, the terms “include” and “or” shall be interpreted as inclusive, unless such an interpretation is expressly prohibited herein. Where the term “example” is used herein, the “example” is merely illustrative and explanatory and should not be construed as exclusive or exhaustive.

Described above are detailed descriptions of several embodiments of the present disclosure, but it is apparent that a person skilled in the art may make various modifications and variations to the embodiments of the present disclosure without departing from the spirit and scope of the present disclosure. The scope of protection of the present disclosure is defined by the appended claims.

What is claimed is:

1. A control method for a half-bridge flyback converter, the half-bridge flyback converter comprising a primary power circuit and a secondary power circuit coupled to the primary power circuit, wherein the primary power circuit comprises a first primary switching transistor and a second primary switching transistor connected in series between a voltage input terminal and ground and a primary winding, and the secondary power circuit comprises a secondary winding and a secondary switching transistor and an output capacitor electrically connected to two terminals of the secondary winding respectively, wherein the secondary switching transistor and the output capacitor are connected in series;
wherein the control method comprises:
in a case where the half-bridge flyback converter operates in a free resonant state, controlling, in a first switching period, the second primary switching transistor to be ON for a first duration;
in response to detecting, based on sampled voltage information of the secondary power circuit, that the second primary switching transistor is turned on, controlling the secondary switching transistor to be ON for a second duration to cause a magnetizing current to become a negative current; and
in response to the secondary switching transistor being turned off, at a moment having a dead time away from a turn-off moment of the secondary switching transistor, controlling the first primary switching transistor to turn on.

2. The control method according to claim 1, wherein before controlling, in the first switching period, the second primary switching transistor to be ON for the first duration, the method further comprises:
controlling, in the first switching period, the second primary switching transistor to be ON for a third duration to cause the magnetizing current to be zero.

3. The control method according to claim 2, wherein prior to the first switching period, the half-bridge flyback converter continuously operates for N second switching periods, wherein N is an integer greater than or equal to 1; and
before controlling, in the first switching period, the second primary switching transistor to be ON for the third duration, the method further comprises:
in a case where the half-bridge flyback converter continuously operates in a critical conduction mode for the N second switching periods, controlling, in the second switching period, the second primary switching transistor to be ON for a fourth duration to cause the magnetizing current to be a negative current, wherein the fourth duration is greater than the third duration; or
in the half-bridge flyback converter continuously operates in a discontinuous conduction mode for the N the second switching periods, controlling, in the second switching period, the second primary switching transistor to be ON for the third duration.

4. The control method according to claim 1, wherein prior to the first switching period, the half-bridge flyback converter continuously operates in a critical conduction mode for N second switching periods, wherein N is an integer greater than or equal to 1; and
before controlling, in the first switching period, the second primary switching transistor to be ON for the first duration, the method further comprises:
controlling, in the first switching period, the second primary switching transistor to turn off.

5. The control method according to claim 4, wherein before controlling, in the first switching period, the second primary switching transistor to turn off, the method further comprises:
controlling, in the second switching period, the first primary switching transistor to be ON for a fifth duration; and
controlling, in the first switching period, the first primary switching transistor to be ON for a sixth duration, wherein the sixth duration is less than the fifth duration.

6. The control method according to claim 1, wherein the controlling the secondary switching transistor to be ON for the second duration in response to detecting, based on the sampled voltage information of the secondary power circuit, that the second primary switching transistor is turned on comprises:
determining a turn-on moment of the secondary switching transistor based on a valley value of a drain voltage of the secondary switching transistor in the free resonant state; and
controlling, at the turn-on moment, the secondary switching transistor to be ON for the second duration.

7. A control circuit for a half-bridge flyback converter, the half-bridge flyback converter comprising a primary power circuit and a secondary power circuit coupled to the primary power circuit, wherein the primary power circuit comprises a first primary switching transistor and a second primary switching transistor connected in series between a voltage input terminal and ground and a primary winding, and the secondary power circuit comprises a secondary winding and a secondary switching transistor and an output capacitor electrically connected to two terminals of the secondary winding respectively, wherein the secondary switching transistor and the output capacitor are connected in series;
wherein the control circuit comprises a primary control module and a secondary control module; wherein
the primary control module is configured to, in a case where the half-bridge flyback converter operates in a free resonant state, control, in a first switching period, the second primary switching transistor to be ON for a first duration;
the secondary control module is configured to, in response to detecting, based on sampled voltage information of the secondary power circuit, that the second primary switching transistor is turned on, control the secondary switching transistor to be ON for a second duration to cause a magnetizing current to become a negative current; and
the primary control module is further configured to, in response to the secondary switching transistor being turned off, at a moment having a dead time away from a turn-off moment of the secondary switching transistor, control the first primary switching transistor to turn on.

8. The control circuit according to claim 7, wherein the primary control module is further configured to control, in the first switching period, the second primary switching transistor to be ON for a third duration to cause the magnetizing current to be zero.

9. The control circuit according to claim 8, wherein prior to the first switching period, the half-bridge flyback converter continuously operates for N second switching periods, wherein N is an integer greater than or equal to 1; and
the primary control module is further configured to: in a case where the half-bridge flyback converter continuously operates in a critical conduction mode for the N second switching periods, control, in the second switching period, the second primary switching transistor to be ON for a fourth duration to cause the magnetizing current to be a negative current, wherein the fourth duration is greater than the third duration; or in a case where the half-bridge flyback converter continuously operates in a discontinuous conduction mode for the N second switching periods, control, in the second switching period, the second primary switching transistor to be ON for the third duration.

10. The control circuit according to claim 7, wherein prior to the first switching period, the half-bridge flyback converter continuously operates in a critical conduction mode for N second switching periods, wherein N is an integer greater than or equal to 1; and
the primary control module is further configured to control, in the first switching period, the second primary switching transistor to turn off.

11. The control circuit according to claim 10, wherein the primary control module is further configured to: control, in the second switching period, the first primary switching transistor to be ON for a fifth duration, and control, in the first switching period, the first primary switching transistor to be ON for a sixth duration, wherein the sixth duration is less than the fifth duration.

12. The control circuit according to claim 7, wherein the secondary control module is further configured to: determine a turn-on moment of the secondary switching transistor based on a valley value of a drain voltage of the secondary switching transistor in the free resonant state; and control, at the turn-on moment, the secondary switching transistor to be ON for the second duration.

13. A half-bridge flyback converter, comprising: a primary power circuit, a secondary power circuit coupled to the primary power circuit, and a control circuit; wherein
the primary power circuit comprises a first primary switching transistor and a second primary switching transistor connected in series between a voltage input terminal and ground and a primary winding, and the secondary power circuit comprises a secondary winding and a secondary switching transistor and an output capacitor electrically connected to two terminals of the secondary winding respectively, wherein the secondary switching transistor and the output capacitor are connected in series; and
the control circuit comprises a primary control module and a secondary control module; wherein
the primary control module is configured to, in a case where the half-bridge flyback converter operates in a free resonant state, control, in a first switching period, the second primary switching transistor to be ON for a first duration;
the secondary control module is configured to, in response to detecting, based on sampled voltage information of the secondary power circuit, that the second primary switching transistor is turned on, control the secondary switching transistor to be ON for a second duration to cause a magnetizing current to become a negative current; and
the primary control module is further configured to, in response to the secondary switching transistor being turned off, at a moment having a dead time away from a turn-off moment of the secondary switching transistor, control the first primary switching transistor to turn on.

14. The half-bridge flyback converter according to claim 13, wherein the primary power circuit further comprises a resonant inductor, a resonant capacitor, an input capacitor, and a sampling resistor; wherein
a drain of the first primary switching transistor is electrically connected to the voltage input terminal, a source of the first primary switching transistor and a drain of the second primary switching transistor are electrically connected, and a source of the second primary switching transistor is grounded;
a first plate of the input capacitor is electrically connected to the voltage input terminal, a second plate of the input capacitor is grounded, a first terminal of the resonant inductor is electrically connected to a connection node between the source of the first primary switching transistor and the drain of the second primary switching transistor, a second terminal of the resonant inductor is electrically connected to a first terminal of the primary winding, a second terminal of the primary winding is electrically connected to a second terminal of the resonant capacitor, a first terminal of the resonant capacitor is electrically connected to a second terminal of the sampling resistor, and a first terminal of the sampling resistor is grounded.

15. The half-bridge flyback converter according to claim 14, wherein the primary power circuit further comprises an auxiliary winding, a first auxiliary sampling resistor, and a second auxiliary sampling resistor, wherein a first terminal of the auxiliary winding is electrically connected to a first terminal of the first auxiliary sampling resistor, a second terminal of the first auxiliary sampling resistor is electrically connected to a first terminal of the second auxiliary sampling resistor, and a second terminal of the second auxiliary sampling resistor and a second terminal of the auxiliary winding are both grounded; and
the primary control module comprises a first primary drive unit, a second primary drive unit, a primary control unit, a first primary sampling unit, and a second primary sampling unit;
wherein
a first output terminal of the primary control unit is electrically connected to a control terminal of the first primary switching transistor via the first primary drive unit, and a second output terminal of the primary control unit is electrically connected to a control terminal of the second primary switching transistor via the second primary drive unit;
an input terminal of the first primary sampling unit is electrically connected to a connection node between the second terminal of the first auxiliary sampling resistor and the first terminal of the second auxiliary sampling resistor, and an output terminal of the first primary sampling unit is electrically connected to a first input terminal of the primary control unit; and
an input terminal of the second primary sampling unit is electrically connected to a connection node between the second terminal of the sampling resistor and the first terminal of the resonant capacitor, and an output terminal of the second primary sampling unit is electrically connected to a second input terminal of the primary control unit.

16. The half-bridge flyback converter according to claim 15, wherein the secondary winding is coupled to the primary winding, and a first terminal of the secondary winding and a second terminal of the primary winding are corresponding polarity terminals, a first plate of the output capacitor is a voltage output terminal, the first terminal of the secondary winding is electrically connected to the first plate of the output capacitor, a second terminal of the secondary winding is electrically connected to a drain of the secondary switching transistor, and a source of the secondary switching transistor and a second plate of the output capacitor are both grounded; and
the secondary control module comprises a secondary drive unit, a secondary control unit, and a secondary sampling unit;
wherein an output terminal of the secondary control unit is electrically connected to a control terminal of the secondary switching transistor via the secondary drive unit, an input terminal of the secondary sampling unit is electrically connected to a connection node between the second terminal of the secondary winding and the drain of the secondary switching transistor, and an output terminal of the secondary sampling unit is electrically connected to an input terminal of the secondary control unit.

17. The half-bridge flyback converter according to claim 16, wherein the secondary sampling unit is configured to sample a drain voltage of the secondary switching transistor, and transmit the drain voltage of the secondary switching transistor to the secondary control unit; and
the secondary control unit is configured to determine the sampled voltage information of the secondary power circuit based on the drain voltage of the secondary switching transistor, and control, based on the sampled voltage information, the secondary switching transistor to turn on or turn off.

18. The half-bridge flyback converter according to claim 13, wherein the primary power circuit further comprises a resonant inductor, a resonant capacitor, an input capacitor, and a sampling resistor;
wherein
a first plate of the input capacitor is electrically connected to the voltage input terminal, a second plate of the input capacitor is grounded, a drain of the first primary switching transistor is electrically connected to the voltage input terminal, a source of the first primary switching transistor and a drain of the second primary switching transistor are electrically connected, a source of the second primary switching transistor is electrically connected to a first terminal of the sampling resistor, and a second terminal of the sampling resistor is grounded; and
the voltage input terminal is electrically connected to a first terminal of the resonant capacitor, a second terminal of the resonant capacitor is electrically connected to a first terminal of the primary winding, a second terminal of the primary winding is electrically connected to a second terminal of the resonant inductor, and a first terminal of the resonant inductor is electrically connected to a connection node between the source of the first primary switching transistor and the drain of the second primary switch.

19. The half-bridge flyback converter according to claim 18, wherein the primary power circuit further comprises an auxiliary winding, a first auxiliary sampling resistor, a second auxiliary sampling resistor, wherein a first terminal of the auxiliary winding is electrically connected to a first terminal of the first auxiliary sampling resistor, a second terminal of the first auxiliary sampling resistor is electrically connected to a first terminal of the second auxiliary sampling resistor, and a second terminal of the second auxiliary sampling resistor and a second terminal of the auxiliary winding are both grounded; and
the primary control module comprises a first primary drive unit, a second primary drive unit, a primary control unit, a first primary sampling unit, and a second primary sampling unit;
wherein
a first output terminal of the primary control unit is electrically connected to a control terminal of the first primary switching transistor via the first primary drive unit, and a second output terminal of the primary control unit is electrically connected to a control terminal of the second primary switching transistor via the second primary drive unit;
an input terminal of the first primary sampling unit is electrically connected to a connection node between the second terminal of the first auxiliary sampling resistor and the first terminal of the second auxiliary sampling resistor, and an output terminal of the first primary sampling unit is electrically connected to a first input terminal of the primary control unit; and
an input terminal of the second primary sampling unit is electrically connected to a connection node between the first terminal of the sampling resistor and the source of the second primary switching transistor, and an output terminal of the second primary sampling unit is electrically connected to a second input terminal of the primary control unit.

20. The half-bridge flyback converter according to claim 19, wherein the secondary winding is coupled to the primary winding, a first terminal of the secondary winding and a second terminal of the primary winding are corresponding polarity terminals, a first plate of the output capacitor is a voltage output terminal, the first terminal of the secondary winding is electrically connected to a source of the secondary switching transistor, a drain of the secondary switching transistor is electrically connected to the first plate of the output capacitor, and a second terminal of the secondary winding and a second plate of the output capacitor are both grounded; and
the secondary control module comprises a secondary drive unit, a secondary control unit, and a secondary sampling unit;
wherein an output terminal of the secondary control unit is electrically connected to a control terminal of the secondary switching transistor via the secondary drive unit, an input terminal of the secondary sampling unit is electrically connected to a connection node between the drain of the secondary switching transistor and the first plate of the output capacitor, and an output terminal of the secondary sampling unit is electrically connected to an input terminal of the secondary control unit.
